(19) United States
(12) Patent Application Publication
(10) Pub. No.: US 2020/0337126 A1
(43) Pub. Date: Oct. 22, 2020

(54) Electronic Ballast with Single Stage Circuit Structure

(71) Applicant: Shenzhen Number Energy Saving Corporation, Shenzhen (CN)

(72) Inventor: Hongchuan CHEN, Shenzhen (CN)

(73) Assignee: Shenzhen Number Energy Saving Corporation

(21) Appl. No.: 16/666,147

(22) Filed: Oct. 28, 2019

(30) Foreign Application Priority Data
Apr. 19, 2019 (CN) 2019103166088

(51) Int. Cl. H05B 41/24

(52) U.S. Cl. CPC H05B 41/24; H02M 7/06

(57) ABSTRACT

An electronic ballast with a single stage circuit structure includes a detection device for detecting a voltage, current, and phase of an AC input power source; a rectifier bridge; a full bridge inverter circuit; and an inverter controlling circuit. When an output terminal of the full bridge inverter circuit is connected to the gas discharge lamp as a load, the electronic ballast further includes a series resonant capacitor Cs and a series resonant inductor L. By additionally providing the series resonant capacitor Cs and the series resonant inductor L to the electronic ballast, a zero-crossing point of a unidirectional sinusoidal direct current is able to effectively solve the HID extinguishing problem due to under-voltage thereof. Since a conduction angle of the entire unidirectional sinusoidal half wave of the HID is increased, the PF value is effectively increased and the harmonics is effectively reduced.

### BACKGROUND OF THE PRESENT INVENTION

### Field of Invention

The present invention relates to a field of ballasts, and more particularly to an electronic ballast with a single stage circuit structure.

### Description of Related Arts

Electronic ballasts are commonly used in a conventional lighting apparatus, such as HID electronic ballasts for high pressure gas discharging lamp. The conventional electronic ballasts are mainly constructed with a two-stage or even a three-stage circuit structure. These electronic ballasts have complicated structure and relatively high cost. Therefore, the present applicant invented an electronic ballast with a single-stage circuit structure (Chinese Patent Number CN 103369806 B). FIG. 1 illustrates the circuit structure of the single-stage electronic ballast. The single-stage ballast comprises first and second processors U3 and U2 for detecting AC input voltage, current and phase. The single-stage ballast further comprises a rectifier bridge D1 constructed by four diodes, a semiconductor full bridge circuit FB constructed by four semiconductor switches S1/S2/S3/S4, a system-on-chip (SOC) integrated circuit U1, and an inductor L1. The semiconductor full bridge circuit FB is directly and electrically connected in front of the rectifier D1. When the rectifier D1 outputs a unidirectional sinusoidal direct current, the semiconductor full bridge circuit FB is configured to directly convert the unidirectional sinusoidal direct current into the same frequency, in-phase, step-down quasi-sinusoidal alternating current for outputting to the gas discharge lamp so as to electrify the gas discharge lamp. After detecting the AC input voltage, current, and phase, the detection result is input to the system-on-chip (SOC) integrated circuit U1. By controlling the on-and-off manner of the semiconductor switches S1/S2/S3/S4 of the system-on-chip (SOC) integrated circuit U1, the AC current is output by the semiconductor full bridge circuit FB. For example, when the system-on-chip (SOC) integrated circuit U1 determines the input AC power as a positive half cycle, the on-off state of the semiconductor switch of the one side bridge arm as one of a fixed left side bridge arm or a fixed right side bridge arm is remained unchanged. At the same time, another side bridge arm is switched on-and-off in a high speed manner. When the AC current input at a terminal 7 of the system-on-chip (SOC) integrated circuit U1 is a negative half cycle, the switching configuration is adjusted in a reverse order. The on-off states of the left side bridge arm and the right side bridge arm semiconductor switch are opposite. When the semiconductor switch S1 at the left bridge arm and the semiconductor switch S2 at the right bridge arm are switched on, the semiconductor switch S3 at the left bridge arm or the semiconductor switch S4 at the right bridge arm must be switched off, otherwise vice versa.

During the operational process, such single-stage ballast circuit will cause an unstable working operation of the HID lamp when sinusoidal zero crossing, and will have the problems of large harmonics and low PF. These defects in the single-stage ballast product are unacceptable in the current market.

### SUMMARY OF THE PRESENT INVENTION

The invention directs to improve the existing single stage ballast which has the problems of unstable working operation of a HID in a sinusoidal zero crossing point, large harmonics, and low PF (power factor), by providing a novel single stage circuit structure. The output terminal of the electronic ballast is connected to a series resonant capacitor and an inductor in a series connection to overcome the existing single stage ballast in the sinusoidal zero-crossing point which will cause an unstable working operation of HID lamp, and large harmonics, and low the PF.

The technical solution of the present invention is to provide an electronic ballast with a single stage circuit structure, comprising: a detection device configured for detecting a voltage, current, and phase of an AC input power source; a rectifier bridge configured to rectify the AC input power source; a full bridge inverter circuit which comprises four semiconductor switches; and an inverter controlling circuit. The full bridge inverter circuit is set at an output terminal of the rectifier bridge. In response to a detection signal of the voltage, current, and phase of the AC input power source detected by the detection device, the inverter control circuit is configured to generate a time order for controllably switching said four semiconductor switches in an on and off manner. When an output terminal of the full bridge inverter circuit is connected to a gas discharge lamp as a load, the electronic ballast further comprises a series resonant capacitor Cs and a series resonant inductor L.

According to the present invention, the series resonant capacitor Cs and the series resonant inductor L are additionally provided to the electronic ballast of the existing single stage circuit structure. Therefore, the zero-crossing point of the unidirectional sinusoidal direct current is able to effectively solve the HID extinguishing problem due to under-voltage thereof. Since the conduction angle of the entire unidirectional sinusoidal half wave of the HID is increased, the PF value is effectively increased and the THDi (Total Harmonic Current Distortion) is effectively reduced.

Furthermore, according to the above mentioned electronic ballast with the single stage circuit structure, the electronic ballast further comprises a parallel resonant capacitor Cp connected to the gas discharge lamp as a load in a parallel connection. After the initialization of the gas discharge lamp as the load is completed, the parallel resonant capacitor Cp is then connected to a parallel circuit of the gas discharge lamp as the load.

Furthermore, according to the above mentioned electronic ballast with the single stage circuit structure, the electronic ballast further comprises a relay RY1 controlled by the inverter controlling circuit. The relay Y1 is set at the parallel resonant capacitor Cp and is connected to the parallel circuit of the gas discharge lamp as a load.

The present invention will be described from the following accompanying drawings, and the specific embodiments.

### BRIEF DESCRIPTION OF THE DRAWINGS

FIG. 1 is a circuit diagram illustrating a conventional single-stage electronic ballast.

FIG. 2 is a circuit diagram illustrating an electronic ballast with a single stage circuit structure according to a preferred embodiment of the present invention.

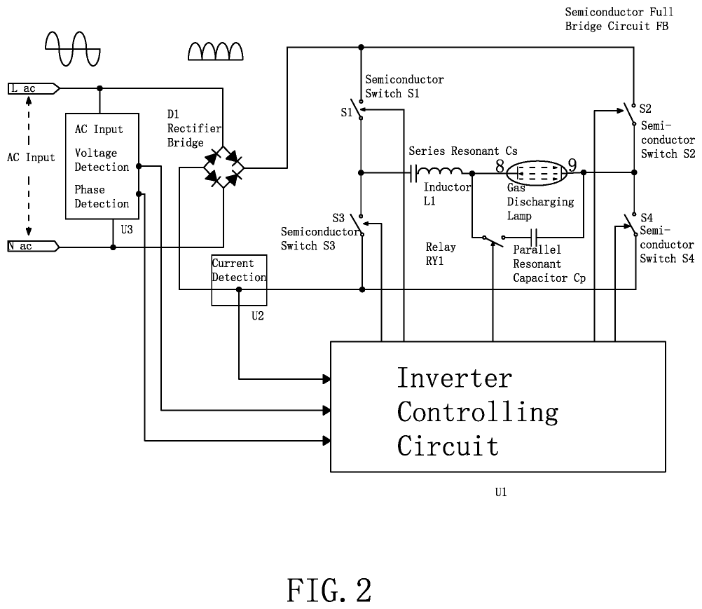

### DETAILED DESCRIPTION OF THE PREFERRED EMBODIMENT

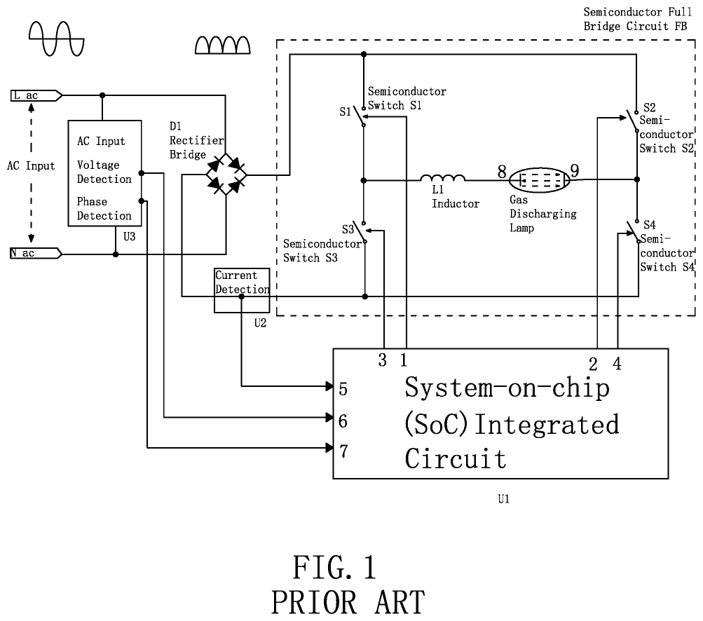

The first embodiment, as shown in FIG. 1, illustrates an electronic ballast with a single stage circuit structure having advantages of enhancing HID stable working operation, suppressing harmonics and increasing power factor (PF). The electronic ballast with the single stage circuit structure of the present invention is configured to incorporate with an inverter controlling circuit U1 to achieve the control of the semiconductor full bridge circuit FB, so s to complete the inversion.

The electronic ballast with an improved single stage circuit structure comprises a detection chip U3 configured for voltage detection and phase detection of an AC input, a current detection chip U2, a rectifier D1 which comprises four diodes, a semiconductor full bridge circuit FB which comprises four semiconductor switches S1/S2/S3/S4, an inverter controlling circuit chip U1, a series resonant inductor L1, a series resonant Cs, a parallel resonant capacitor Cp, and a relay RY1. The semiconductor full bridge circuit FB is directly connected in front of the rectifier bridge D1. When the rectifier bridge D1 outputs a unidirectional sinusoidal direct current, the semiconductor full bridge circuit FB is configured to directly convert the unidirectional sinusoidal direct current into the same frequency and in-phase quasi-sinusoidal alternating current for outputting to the HID lamp so as to electrify the lamp. After the HID lamp is lit, the relay RY1 is closed, so that the FB circuit is operated under a SPRC (series-parallel resonant converter) mode. Therefore, the zero-crossing point of the unidirectional sinusoidal direct current is able to effectively solve the HID extinguishing problem due to under-voltage thereof. Since the conduction angle of the entire unidirectional sinusoidal half wave of the HID is increased, the PF value is effectively increased and the THDi is effectively reduced.

In this embodiment, the power source of the gas discharge lamp is a commercial power source, i.e. 220 VAC. In this embodiment, the input terminal of the main supply directly detects the input voltage of the main supply. Currently, there are many existing voltage detections circuits. For example, the analog voltage signal generated by the circuit after the input voltage is stepped down can be used to indicate the value of the main supply voltage. Also, there are many existing phase detection circuits (meters). In this embodiment, the phase detection circuit and the voltage detection circuit are integrated to form the detection chip U3 for detecting the voltage and phase of the AC input. The chip U3 being used by the applicant is a plant artificial light apparatus to highly reduce the circuit board size of the plant fill light product. The input current is detected by a negative charge returning current of the current detection chip U2 output from the rectifier bridge D1. In this embodiment, the voltage value, the current value and the current phase angle detected by the AC input voltage and phase detection chip U3 and the current detection chip U2 are input to the inverter controlling circuit chip U1. By processing the inverter controlling circuit chip U1, a time ordering signal is generated to controllably switch on-and-off the four semiconductor switches S1/S2/S3/S4 of the semiconductor full bridge circuit FB in a timely ordering manner. In this embodiment, the inverter controlling circuit chip U1 is an intelligent chip that integrates a processor, a memory, an AD converter, etc., together. Practically, the applicant widely uses the chip in the plant artificial light apparatus as a single-chip microcomputer. In this embodiment, the four semiconductor switches S1/S2/S3/S4 can be replaced by MOS transistor, wherein the D-S pole of the MOS transistor is configured to form one arm of the semiconductor full bridge circuit FB, and the G pole is connected to the inverter controlling circuit chip U1. Then, the inverted controlling circuit chip U1 is configured to generate a communicating signal to control the on-and-off stage thereof.

In this embodiment, there is only one single stage circuit formed between the output of the rectifier bridge D1 and the gas discharge lamp. The single stage circuit is constructed by the semiconductor switch S1, the semiconductor switch S2, the semiconductor switch S3, the semiconductor switch S4, the series resonant inductor L1, the series resonant Cs, the parallel resonant capacitor Cp, the relay RY1, to form the full bridge resonant circuit FB, wherein the timing control of the semiconductor switch is controlled by the inverter controlling circuit chip U1.

When the semiconductor full bridge circuit FB is under the control of the inverter controlling circuit chip U1, the semiconductor switch S1 and the semiconductor switch S3, and the semiconductor switch S2 and the semiconductor switch S4 are electrically conducted complementary in one cycle. There are conduction phase angles formed between the semiconductor switch S1 and the semiconductor switch S4 and between the semiconductor switch S2 and the semiconductor switch S3. The inverter controlling circuit chip U1 is configured to control the output power by adjusting the conduction phase angle in order to obtain the power factor compensation APFC function.

Comparing to the existing two-stage or three stage blast circuit, the electronic ballast of the improved single-stage circuit structure of the present embodiment does not require a large capacity filter capacitor after the rectifier bridge D1. The rectifier bridge D1 of the present invention is configured to output a unidirectional, sinusoidal DC power without any requiring any filtering process to convert into a flat DC current. Instead, the unidirectional, sinusoidal undulating DC current is directly converted into a quasi-sinusoidal AC current with the same frequency, in phase, and step-down AC input, so as to directly output to the gas discharge lamp. Comparing to the existing electronic ballast of single-stage circuit structure, the present invention incorporates with the series resonant capacitor Cs, the parallel resonant capacitor Cp, and the relay RY1. When initializing, the relay RY1 is disconnected to prevent excessive initializing current passing through the semiconductor full bridge circuit FB to damage the four semiconductor switches thereof. After the initialization, the relay RY1 is closed, and the resonant capacitor Cp is connected with the HID lamp in a parallel connection and is connected with the resonant capacitor Cs and the resonant inductor L1 in series and parallel resonance manner. The HID lamp has a gain higher than 1 at the zero-crossing point of the unidirectional sinusoidal direct current. The capacities of the resonant capacitor Cs, the parallel resonant capacitor Cp and the resonant inductor L1 can be calculated and determined by those skilled in the art in order to increase the conduction time of the HID in the unidirectional, sinusoidal period. Therefore, the HID current waveform is formed close to the unidirectional, sinusoidal voltage waveform to increase the PF value of the circuit and lower the THDi.

The electronic ballast of the single-stage circuit structure of the present embodiment is used in plant artificial light apparatus with a good and effective effect. Currently, for both 50 Hz and 60 Hz of the power supply, the electronic ballast of the present invention can be used for different voltages of 277V, 240V, 220V, 208V, and 120V. The power supply is connected to the diode rectifier bridge D1, and at the same time, the voltage and phase detection circuit U3 is connected to two terminal ends of the AC input power source. The voltage and phase detection circuit U3 is configured to convert the AC voltage value and the real-time phase into corresponding weak electric signals and respectively sends them to the inverter controlling circuit chip U1 of the electronic ballast of the plant artificial light apparatus designed by the applicant. The rectifier bridge D1 is configured to convert the sinusoidal alternating current into a unidirectional, sinusoidal, direct current. It is worth mentioning that the undulating DC is not filtered by the capacitor with a relative large capacity, but is directly sent to the semiconductor full bridge circuit FB constructed by four semiconductor switches S1/S2/S3/S4.

The semiconductor full bridge circuit FB comprises a left side bridge arm and a right side bridge arm. The left side bridge arm is constructed by an upper left side bridge arm semiconductor switch Si and a lower left side arm semiconductor switch S3. The right bridge arm is constructed by an upper right side bridge arm semiconductor switch S2 and a lower right side arm semiconductor switch S4. The upper left side bridge arm semiconductor switch S1 and the lower left side arm semiconductor switch S3 of the left side bridge arm are respectively connected to and controlled by the two terminals of the inverter controlling circuit chip U1. The upper right side bridge arm semiconductor switch S2 and the lower right side arm semiconductor switch S4 are respectively connected to and controlled by the two terminals of the inverter controlling circuit chip U1. The upper left side arm semiconductor switch S1 and the lower left side arm semiconductor switch S3, and the upper right side arm semiconductor switch S2 and the lower right side arm semiconductor switch S4 are electrically conducted complementarily in one cycle. There are conduction phase angles between the upper left side arm semiconductor switch S1 and the lower right side arm semiconductor switch S4, and between the upper right side arm semiconductor switch S2 and the lower left side arm semiconductor switch S3. By controlling the magnitude of the conduction phase angle, the current passing through the gas discharge lamp can be controlled as a rated current corresponding to the rated power of the lamp. The current passing to the lamp is controlled not to be too large or too small. The feedback detection of such current is sent from the current detection U2 to the terminal of the inverter controlling circuit chip U1. Accordingly, the current detection signal is configured to represent the magnitude of the current output from a center point of the semiconductor full bridge circuit FB to the inductor L1 and then sent to the lamp. According to the current input terminal, the inverter controlling circuit chip U1 is configured to receive the current detection signal from the circuit detection circuit U2. According to the sampled current value, the inverter controlling circuit chip U1 is configured to, through an internal program algorithm, calculate and determine the upper left bridge arm semiconductor switch S1 and the lower right side bridge arm semiconductor switch S4, the conduction phase angle between the upper right side bridge arm semiconductor switch S2 and the lower left side arm semiconductor switch S3 and output the corresponding control signal, so as to output a constant power of the HID lamp.

The inverter controlling circuit chip U1 is configured to detect the lamp current and AC input voltage through its terminal in a real time manner in order to obtain over-voltage and over-current protection through its internal calculation and logic determination function.

1. According to the semiconductor full bridge circuit FB, the upper left side bridge arm semiconductor switch S1 and the lower right side arm semiconductor switch S4, and the upper right side bridge arm semiconductor switch S2 and the lower left side arm semiconductor switch S3 are electrically conducted complementarily in one cycle. The conduction phase angles are formed between the upper left side arm semiconductor switch S1 and the lower right side arm semiconductor switch S4, and between the upper right side arm semiconductor switch S2 and the lower left side arm semiconductor switch S3. Through the detection of the magnitude of the HID lamp current, the inverter control circuit chip U1 is configured to compare the HID lamp current with a preset threshold, to calculate the conduction phase angles of S1 and S4, S2 and S3, and to control the output power by adjusting the conduction phase angles.

2. The series resonant capacitor Cs, the parallel resonant capacitor Cp, and the relay RY1 are additionally provided. When initializing, the relay RY1 is disconnected to prevent excessive initializing current passing through the semiconductor full bridge circuit FB to damage the four semiconductor switches thereof. After the initialization, the relay RY1 is closed, and the resonant capacitor Cp is connected with the HID lamp in a parallel connection and is connected with the resonant capacitor Cs and the resonant inductor L1 in series and parallel resonance manner. The HID lamp has a gain higher than 1 at the zero-crossing point of the unidirectional sinusoidal direct current. The capacities of the resonant capacitor Cs, the parallel resonant capacitor Cp and the resonant inductor L1 can be calculated and determined by those skilled in the art in order to increase the conduction time of the HID in the unidirectional, sinusoidal period. Therefore, the HID current waveform is formed close to the unidirectional, sinusoidal voltage waveform to increase the PF value of the circuit and lower the THDi.

What is claimed is:

1. An electronic ballast, comprising:
a detection device configured for detecting a voltage, current, and phase of an AC input power source;
a rectifier bridge configured to rectify said AC input power source;
a full bridge inverter circuit which comprises four semiconductor switches; and
an inverter controlling circuit;
wherein said full bridge inverter circuit is set at an output terminal of said rectifier bridge;
wherein in response to a detection signal of said voltage, current, and phase of said AC input power source detected by said detection device, said inverter control circuit is configured to generate a time order for controllably switching said four semiconductor switches in an on and off manner, wherein it is characterized in that when an output of the full bridge inverter circuit is connected to a gas discharge lamp as a load, said electronic ballast further comprises a series resonant capacitor Cs and a series resonant inductor L.

2. The electronic ballast, as recited in claim 1, further comprising a parallel resonant capacitor Cp configured for connecting to the gas discharge lamp as the load in a parallel connection, wherein after an initialization of the gas discharge lamp as the load is completed, said parallel resonant capacitor Cp is then connected to a parallel circuit of the gas discharge lamp as the load.

3. The electronic ballast, as recited in claim 2, further comprising a relay RY1 controlled by said inverter controlling circuit, wherein said relay Y1 is set at said parallel resonant capacitor Cp and is configured for connecting to the parallel circuit of the gas discharge lamp as the load.
